(19) United States
(12) Patent Application Publication
(10) Pub. No.: US 2004/0203159 A1
(43) Pub. Date: Oct. 14, 2004

(54) Use of fluorescent dyes based on pyrromethene difluoroborate complexes for the fluorescent marking of lubricants and for the determination of leakages in lubricant systems and a corresponding fluorescent dye concentrate

(75) Inventors: Christoph Zander, Freudenberg (DE); Birgitt Zander, Freudenberg (DE); Rene Puschl, Ludenscheid (DE)

Correspondence Address: HENRY M FEIEREISEN, LLC, 350 FIFTH AVENUE, SUITE 4714, NEW YORK, NY, 10118, US

(73) Assignee: CERTUS DUR GMBH, Freudenberg (DE)

(21) Appl. No.: 10/789,419

(22) Filed: Feb. 27, 2004

Related U.S. Application Data
(63) Continuation of application No. PCT/EP02/09655, filed on Aug. 29, 2002.

(30) Foreign Application Priority Data
Aug. 30, 2001 (DE) 101 42 121.4

(51) Int. Cl. G01M 3/04; G01N 31/00

(52) U.S. Cl. 436/3

(57) ABSTRACT

Use of fluorescent dyes based on pyrromethene difluoroborate complexes is disclosed for use in fluorescent marking of lubricants and fro the determination of leakages in lubricant systems and a corresponding fluorescent dye concentrate.

### CROSS-REFERENCES TO RELATED APPLICATIONS

This application is a continuation of prior filed copending PCT International application No. PCT/EP02/09655, filed Aug. 29, 2002.

This application claims the priority of German Patent Application Serial No. 101 42 121.4, filed Aug. 30, 2001, pursuant to 35 U.S.C. 119(a)-(d), the subject matter of which is incorporated herein by reference.

### BACKGROUND OF THE INVENTION

The present invention relates to the use of fluorescent dyes based on pyrromethene difluoroborate complexes for fluorescent marking of lubricants and for leak detection in lubricant systems and a corresponding fluorescent dye concentrate.

There exists a wide range of technical installations and applications, for example hydraulic systems, aircraft engines, the automotive sector where early detection of leaks and potential leaks is particularly important. One benefit of early detection is the ability to minimize machine outages and expenditures on maintenance and repairs. Another benefit is the ability to enhance the systems' operational reliability, for example in order to avoid harm to people or the environment.

Different methods can be employed to detect a leak from a lubricant system. Visual localization of the leak is among the most sensitive. The localization of a leak in a lubricant system can be optimized by marking the lubricants in the installation with fluorescent dyes. When using fluorescent dyes, a leak will cause fluorescent dye to escape together with the lubricant. By exciting the escaping fluorescent dye with light (for example a UV or black light lamp), the fluorescence of the dye can be observed on the surface.

To minimize the cost and inconvenience of marking the lubricant in an installation lubricant system, it is necessary that the fluorescent dye be available in the form of a liquid fluorescent dye concentrate, which is most advantageously oil-based. The fluorescent dye concentrate can thus be added to the lubricant system of the desired installation and mixed within the system with the lubricant. In order to introduce as little of the fluorescent dye concentrate as possible into the lubricant system, the concentration of the dye in the fluorescent dye concentrate should be as high as possible.

Heretofore a multiplicity of fluorescent dyes, such as for example rhodamines, oxazines or coumarins have been developed which possess a high fluorescence quantum yield and are excitable with UV a UV lamp. However, these dyes are not particularly highly soluble in oil. In general, about 2 grams of these dyes can be dissolved in 1 liter of oil. Good visibility of the fluorescence of these dyes to the naked eye on UV excitation requires a concentration of about 0.2 gram per liter of oil of these dyes. For this reason, these dyes only permit the preparation of fluorescent dye concentrates which permit a ratio of one to ten for fluorescent dye concentrate to lubricant.

U.S. Pat. No. 4,278,444 (filed 1981) to Mobil Oil Corporation utilizes the “Color No. 131 Super Concentrate” dye concentrate from Morton Chemical Company. This fluorescent dye concentrate consists of the fluorescent dye “Fluorescent Yellow” and petroleum solvent. This liquid fluorescent dye concentrate emits a readily visible fluorescence down to a dilution ratio of one to one thousand for fluorescent dye concentrate to lubricant upon excitation with a UV lamp.

Due to the applicable safety regulations, those lubricants which conform to the German Regulation on Flammable Liquids (VbF) AIII, in practice have been proven to be best colored with fluorescent dye concentrates using solvents. The petroleum solvent of the above-described concentrate “Color No. 131 Super Concentrate” however, does not conform to the specification of this regulation and is therefore unsuitable for a whole series of applications.

The above-described well-known fluorescent dyes such as rhodamines, oxazines and coumarins can also be utilized to prepare fluorescent dye concentrates, however this requires the use of solvents such as ethanol or nitrobenzene. Due to the above-described requirement of the German Regulation on Flammable Liquids AIII, such fluorescent dye concentrates can therefore not be used. Moreover, use of solvents such as nitrobenzene is completely out of the question in virtually all cases, due to their toxicity. For instance, nitrobenzene is categorized as carcinogenic, toxic and harmful to the environment by EC directives.

It would therefore be desirable and advantageous to provide improved fluorescent dyes for use in the early detection of leaks and potential leaks in order to obviate prior art shortcomings and to provide fluorescent dyes which are more suitable and conform to applicable regulations.

### SUMMARY OF THE INVENTION

According to one aspect of the present invention, a fluorescent dye system is provided which is suitable for coloring lubricants which take the German Regulation on Flammable Liquids (VbF) AIII into account with which a very high dilution can be realized and which have a high fluorescence quantum yield.

This aspect and others are achieved by various embodiments. In particular, use of fluorescent dyes based on pyrromethene difluoroborate complexes having the general formula (I)

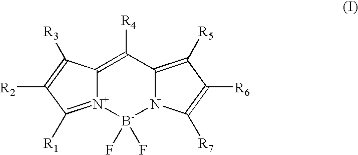

where R₁, R₂, R₃, R₅, R₆ and R₇ are independently hydrogen or straight-chain or branched-chain C₁-C₄-alkyl radicals, preferably methyl, ethyl or propyl, or the R₁ and R₂ and the R₆ and R₇ pairs are part of a fused aromatic ring system and R₄ is a straight-chain or branched-chain C₁-C₁₀-alkyl radical, for fluorescent marking of lubricants and for detecting leakage in lubricant systems.

The present invention resolves prior art problems by the group of pyrromethene dyes having a high fluorescence quantum yield (>80%). The use according to the present invention preferably employs the pyrromethene fluoroborate complexes having the general formula (I) in octanoic acid solvent.

It is another aspect of the present invention to provide a fluorescent dye concentrate comprising at least one fluorescent dye based on pyrromethene difluoroborate complexes having the general formula (I)

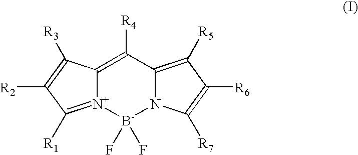

where R₁, R₂, R₃, R₅, R₆ and R₇ are independently hydrogen or straight-chain or branched-chain C₁-C₄-alkyl radicals, preferably methyl, ethyl or propyl, or the R₁ and R₂ and the R₆ and R₇ pairs are part of a fused aromatic ring system and R₄ is a straight-chain or branched-chain C₁-C₁₀-alkyl radical, and octanoic acid solvent. The concentration ratio of the fluorescent dye dissolved in octanoic acid is in the range from about 150 g of the fluorescent dye in 100 g of octanoic acid (minimum) to about 350 g of the fluorescent dye in 100 g of octanoic acid (maximum) and preferably in the range from 210.8 g of the fluorescent dye in 100 g of octanoic acid (minimum) to 285.2 g of the fluorescent dye in 100 g of octanoic acid (maximum). Typically, the concentration ratio is 248 g of the fluorescent dye in 100 g of octanoic acid.

The fluorescent dye concentrates according to the invention are based on octanoic acid as a liquid. This liquid conforms to the VbF AIII flashpoint specification. The fluorescent dye concentrate according to the invention is further miscible with oil in any desired proportion. The concentration ratio of the fluorescent dye concentrate mixed with the oil is preferably in the range from about 0.1 g of fluorescent dye concentrate in 1 liter of oil (minimum) to about 1 g of the fluorescent dye concentrate in 1 liter of oil (maximum) and especially in the range from 0.238 g of the fluorescent dye concentrate in 1 liter of oil (minimum) to 0.322 g of the fluorescent dye concentrate in 1 liter of oil (maximum). Typically, the concentration ratio is 0.28 g of the fluorescent dye concentrate in 1 liter of oil. This results accordingly in particular in a concentration of 0.17 g of the fluorescent dye in 1 liter of oil (minimum) to 0.23 g of the fluorescent dye in 1 liter of oil (maximum). Typically, the concentration ratio is 0.2 g of the fluorescent dye in 1 liter of oil.

For this reason, this fluorescent dye concentrate can be used to prepare oil-based fluorescent dye concentrates. Moreover, this liquid (octanoic acid) is itself not a solvent and can be used in solvent-critical applications as well. The fluorescent dye concentrate according to the invention is particularly advantageous in that it responds to excitation by a UV lamp with fluorescence which is still readily visible to the naked eye down to a dilution ratio of 1 to 2 000 for fluorescent dye concentrates to lubricant. It is consequently possible for the amount of fluorescent dye concentrate to be introduced into the lubricant system to be distinctly reduced.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIGURE 1 shows the absorption and fluorescence spectrum of the pyrromethene dye 4,4,difluoro-2,6-diethyl-1,3,5,7-tetramethyl-8-heptyl-4-bora-3a, 4a-diaza-s-indacene in ethanol according to the present invention;

### DETAILED DESCRIPTION OF PREFERRED EMBODIMENTS

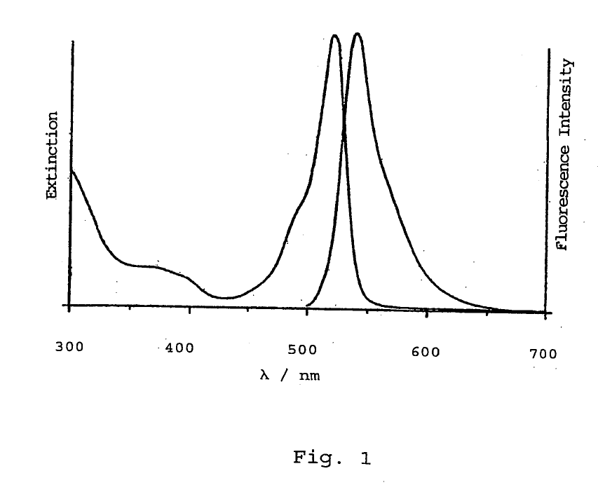

Turning now to FIGURE 1, there is shown the absorption and fluorescence spectrum of the pyrromethene dye 4,4,difluoro-2,6-diethyl-1,3,5,7-tetramethyl-8-heptyl-4-bora-3a, 4a-diaza-s-indacene in ethanol. The wavelength λ is plotted on the x-axis in nm; the absorbance, which goes with the right-hand graph, on the right-hand Y-axis and the emission or fluorescence intensity, which goes with the left-hand graph, on the left-hand Y-axis.

The absorption maxima of the pyrromethene fluorescent dyes used according to the present invention lie in the wavelength range from 390 to 525 nm, the fluorescence maxima in the wavelength range from 427 to 545 nm. Owing to a broad absorption band in the ultraviolet spectrum (see FIGURE 1), these dyes are particularly easy to excite for fluorescence using black light lamps (wavelength ˜366 nm). Owing to their strong fluorescence, these dyes can be used even when there is appreciable contamination of the oils and fats. The fluorescence of the pyrromethene fluorescent dyes used according to the invention is so high that it is still readily observable to the naked eye even in a 2 000-fold dilution of the fluorescent dye concentrate with oil on excitation with a commercially available black light lamp.

The R₁, R₂, R₃, R₄, R₆ and R₇ radicals in the formula (I) may independently be hydrogen or straight-chain or branched-chain C₁-C₄-alkyl radicals, preferably methyl, ethyl or propyl, or the R₁ and R₂ and R₆ and R₇ pairs may be part of a fused aromatic ring system, for example a fused benzene ring. R₄ is a straight-chain or branched-chain C₁-C₁₀-alkyl radical, preferably n-butyl, n-pentyl, n-hexyl or n-heptyl.

The preparation of a fluorescent dye concentrate according to the invention will now be described by way of example for 4,4-difluoro-2,6-diethyl-1,3,5,7-tetramethyl-8-heptyl4-bora-3a, 4a-diaza-s-indacene in octanoic acid.

A solution of 50.0 g (0.41 mol) of 2,4-dimethyl-3-ethylpyrrole in 410 ml of methylene chloride is admixed with 100 g (0.62 mol) of octanoyl chloride added dropwise with stirring over 30 minutes. The reaction solution is refluxed (40° C.) for 60 minutes. The cooled mixture is admixed with 3 500 ml of n-pentane and stirred for 15 hours. The methylene chloride/n-pentane solvent mixture is distilled off on a rotary evaporator. A dark red viscid mixture is left behind as residue. It is converted into a suspension by addition of 1 700 ml of toluene. The suspension is admixed with 41 ml (0.30 mol) of triethylamine added slowly with stirring at room temperature. The reaction mixture is stirred for a further 15 minutes. It is admixed with 145 ml (1.15 mol) of boron trifluoride/diethyl ether complex added dropwise with continued stirring. A green fluorescence is noticeable under UV light. The mixture is heated to 80° C. for 15 minutes with stirring, then cooled down to 40° C. and extracted with a total of 2 000 ml of warm water. This converts the unconverted octanoyl chloride into octanoic acid. Also, water-soluble impurities are transferred into the aqueous phase. The organic phase is dried over anhydrous magnesium sulfate for 18 hours. After the magnesium sulfate has been filtered off, the solvent mixture consisting of toluene, triethylamine and unconsumed boron trifluoride/diethyl ether complex is distilled off on a rotary evaporator. This leaves a viscid dark red residue. The dye can be isolated (purified) by column chromatography (chloroform/silica gel). To produce the fluorescent dye concentrate, the purified dye is dissolved in high concentration in octanoic acid. The concentration ratio of the fluorescent dye dissolved in the octanoic acid is in the range from about 150 g of fluorescent dye in 100 g of octanoic acid (minimum) to about 350 g of the fluorescent dye in 100 g of octanoic acid (maximum) and preferably in the range from 210.8 g of the fluorescent dye in 100 g of octanoic acid (minimum) to 285.2 g of the fluorescent dye in 100 g of octanoic acid (maximum). Typically, the concentration ratio is 248 g of the fluorescent dye in 100 g of octanoic acid.

While the invention has been illustrated and described as embodied in fluorescent dyes, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

1. A method for the detection of leakage in lubricant systems comprising the steps of: marking a lubricant with a fluorescent dye based on pyrromethene difluoroborate complexes having the general formula (I) 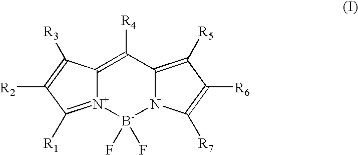
where R1, R2, R3, R5, R6 and R7 are independently hydrogen or straight-hain or branched-chain C1-C4-alkyl radicals or the R1 and R2 and the R6 and R7 pairs are part of a fused aromatic ring system and R4 is a straight-chain or branched-chain C1-C10-alkyl radical, and detecting the fluorescence by detection means.

2. The method according to claim 1, wherein the fluorescent dye based in pyrromethene difluoroborate complexes having the general formula (I) has been dissolved in octanoic acid.

3. The method according to claim 1, wherein the fluorescent dye based on pyrromethene difluoroborate complexes having the general formula (I) 4,4-difluoro-2,6-diethyl-1,3,5,7-tetramethyl-8-heptyl-4-bora-3a,4a-diaza-s-indacene is selected.

4. A fluorescent dye concentrate comprising at least one fluorescent dye based on pyrromethene difluoroborate complexes having the general formula (I) 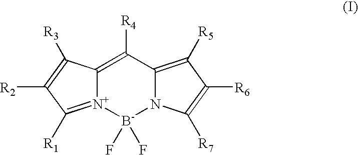
where R1, R2, R3, R5, R6 and R7 are independently hydrogen or straight-chain or branched-chain C1-C4-alkyl radicals or the R1 and R2 and the R6 and R7 pairs are part of a fused aromatic ring system and R4 is a straight-chain or branched-chain C1-C10 alkyl radical, and octanoic acid solvent.

5. The fluorescent dye concentrate according to claim 4, herein the concentration ratio of the fluorescent dye dissolved in octanoic acid is in the range from 150 g of the fluorescent dye in 100 g of octanoic acid to 350 g of the fluorescent dye in 100 g of octanoic acid.

6. The fluorescent dye concentrate according to claim 4, wherein the fluorescent dye based on pyrromethene difluoroborate complexes having the general formula (I) 4,4-difluoro-2,6-diethyl-1,3,5,7-tetramethyl-8-heptyl-4-bora-3a,4a-diaza-s-indacene is selected.
